(19) United States
(12) Patent Application Publication
(10) Pub. No.: US 2022/0366427 A1
(43) Pub. Date: Nov. 17, 2022

(54) SYSTEMS AND METHODS RELATING TO ARTIFICIAL INTELLIGENCE LONG-TAIL GROWTH THROUGH GIG CUSTOMER SERVICE LEVERAGE

(71) Applicant: Genesys Cloud Services, Inc., Daly City, CA (US)

(72) Inventors: Daniel Stewart Stoops, Daly City, CA (US); Cliff W. Bell, Daly City, CA (US)

(21) Appl. No.: 17/742,090

(22) Filed: May 11, 2022

Related U.S. Application Data
(60) Provisional application No. 63/187,058, filed on May 11, 2021.

(51) Int. Cl. G06Q 30/00; G06N 5/02; G06F 40/40

(52) U.S. Cl. CPC G06Q 30/016; G06N 5/022; G06F 40/40

(57) ABSTRACT

A method of training an artificial intelligence system to handle long-tail interactions according to an embodiment includes receiving a user question from a user, analyzing the user question with a natural language understanding engine to determine whether an intent of the user question matches an answer in an answer knowledgebase of the system, transferring at least the user question of the interaction to a primary subject matter expert in response to determining that the intent of the user question does not match an answer in the answer knowledgebase, receiving an expert answer to the user question from the primary subject matter expert, transferring an interaction package including the user question and the expert answer to at least one evaluator for validation, and automatically training the natural language understanding engine based on the user question and the expert answer in response to successful validation of the expert answer.

### CROSS-REFERENCE TO RELATED APPLICATIONS

This application claims priority to and the benefit of U.S. Provisional Application No. 63/187,058, titled “Systems and Methods Relating to Artificial Intelligence Long-Tail Growth Through Gig Customer Service Leverage,” filed on May 11, 2021, the contents of which are incorporated herein by reference in their entirety.

### BACKGROUND

Call centers and other contact centers are used by many organizations to provide technical and other support to their end users. The end user may interact with human and/or virtual agents of the contact center by establishing electronic communications via one or more communication technologies including, for example, telephone, email, web chat, Short Message Service (SMS), dedicated software application(s), and/or other technologies. Contact centers may utilize various types of virtual agents and/or chat bots depending on the particular implementation. For example, a long-tail bot may have the ability to answer more unique questions, whereas a short-tail bot may handle simple questions that are common (e.g., frequently asked questions).

### SUMMARY

One embodiment is directed to a unique system, components, and methods for training an artificial intelligence system to handle long-tail interactions. Other embodiments are directed to apparatuses, systems, devices, hardware, methods, and combinations thereof for training an artificial intelligence system to handle long-tail interactions.

According to an embodiment, a system for training an artificial intelligence system to handle long-tail interactions may include at least one processor and at least one memory comprising a plurality of instructions stored therein that, in response to execution by the at least one processor, causes the system to receive a user question from an interaction between a user and a chatbot, analyze the user question with a natural language understanding engine to determine whether an intent of the user question matches an answer in an answer knowledgebase of the system, transfer at least the user question of the interaction to a primary subject matter expert in response to a determination that the intent of the user question does not match an answer in the answer knowledgebase of the system. receive an expert answer to the user question from the primary subject matter expert, transfer an interaction package to at least one evaluator for validation, wherein the interaction package comprises the user question and the expert answer to the user question, and automatically train the natural language understanding engine based on the user question and the expert answer in response to successful validation of the expert answer by the at least one evaluator.

In some embodiments, the at least one evaluator may include a secondary subject matter expert.

In some embodiments, the plurality of instructions may further cause the system to transmit a response to the user question to the user via the chatbot, wherein the response includes the expert answer.

In some embodiments, the plurality of instructions may further cause the system to receive a user rating of a quality of the expert answer from the user.

In some embodiments, to automatically train the natural language understanding engine may include to automatically train the natural language understanding engine in response to successful validation by the at least one evaluator and receipt of a favorable user rating of the quality of the expert answer from the user.

In some embodiments, the plurality of instructions may further cause the system to transmit a matching answer to the user question via the chatbot in response to a determination that the intent of the user question matches an answer in the answer knowledgebase of the system.

In some embodiments, the plurality of instructions may further cause the system to add a question-answer pair to the answer knowledgebase of the system in response to successful validation of the expert answer by the at least one evaluator.

In some embodiments, to train the natural language understanding engine may include to update an artificial intelligence model.

In some embodiments, the answer knowledgebase may include expert answered questions.

In some embodiments, the answer knowledgebase may include frequently asked questions.

According to another embodiment, a method of training an artificial intelligence system to handle long-tail interactions may include receiving a user question from an interaction between a user and a chatbot, analyzing the user question with a natural language understanding engine to determine whether an intent of the user question matches an answer in an answer knowledgebase of the system, transferring at least the user question of the interaction to a primary subject matter expert in response to determining that the intent of the user question does not match an answer in the answer knowledgebase of the system, receiving an expert answer to the user question from the primary subject matter expert, transferring an interaction package to at least one evaluator for validation, wherein the interaction package comprises the user question and the expert answer to the user question, and automatically training the natural language understanding engine based on the user question and the expert answer in response to successful validation of the expert answer by the at least one evaluator.

In some embodiments, the at least one evaluator may include a secondary subject matter expert.

In some embodiments, the method may further include transmitting a response to the user question to the user via the chatbot that includes the expert answer.

In some embodiments, the method may further include receiving a user rating of a quality of the expert answer from the user.

In some embodiments, automatically training the natural language understanding engine may include automatically training the natural language understanding engine in response to successful validation by the at least one evaluator and receipt of a favorable user rating of the quality of the expert answer from the user.

In some embodiments, the method may further include transmitting a matching answer to the user question via the chatbot in response to determining that the intent of the user question matches an answer in the answer knowledgebase of the system.

In some embodiments, the method may further include adding a question-answer pair to the answer knowledgebase of the system in response to successful validation of the expert answer by the at least one evaluator.

In some embodiments, training the natural language understanding engine may include updating an artificial intelligence model.

In some embodiments, the answer knowledgebase may include expert answered questions.

In some embodiments, the answer knowledgebase may include frequently asked questions.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of a computing device;

FIG. 2 is a simplified block diagram of at least one embodiment of a contact center system and/or communications infrastructure;

FIG. 3 is a simplified block diagram of at least one embodiment of a chat server of the contact center system of FIG. 2;

FIG. 4 is a simplified block diagram of at least on embodiment of a chat module;

FIG. 5 is a simplified diagram of an example customer chat interface;

FIG. 6 is a simplified block diagram of at least one embodiment of a customer automation system;

FIG. 7 is a simplified flow diagram of at least one embodiment of a method of automating an interaction on behalf of a customer;

FIGS. 8-9 are a simplified flow diagram of at least one embodiment of a method of training an artificial intelligence system to handle long-tail interactions; and

FIG. 10 is a simplified diagram of at least one embodiment of a system for leveraging gig customer service.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

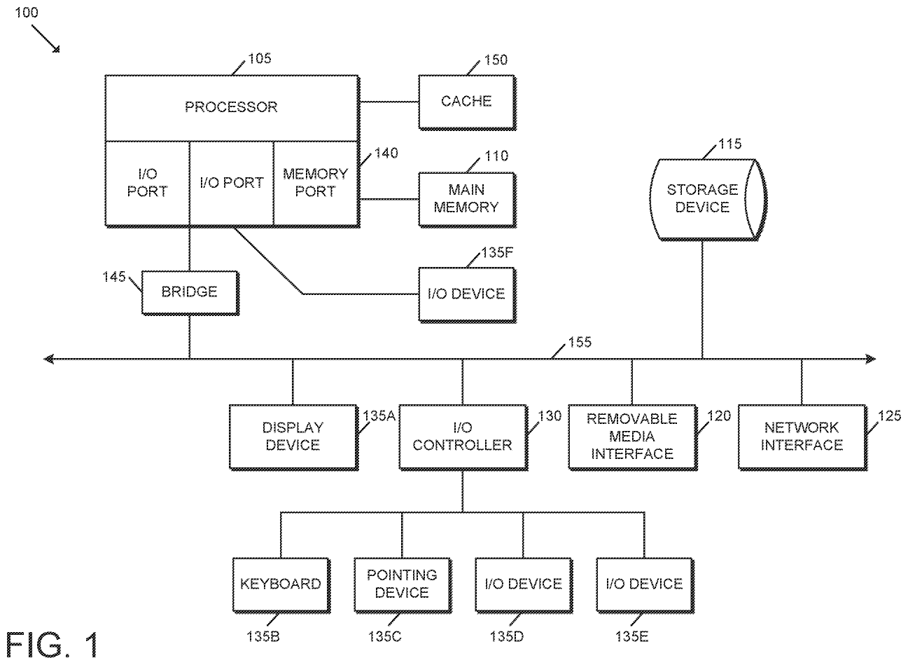

Referring now to FIG. 1, a simplified block diagram of at least one embodiment of a computing device 100 is shown. The illustrative computing device 100 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the servers may be a process or thread running on one or more processors of one or more computing devices 100, which may be executing computer program instructions and interacting with other system modules in order to perform the various functionalities described herein.

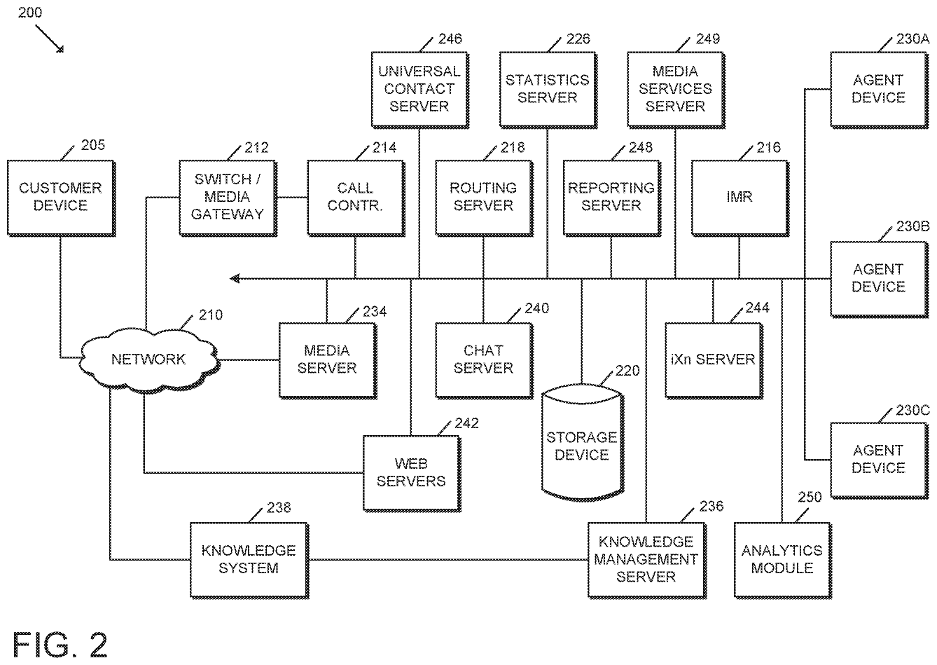

Unless otherwise specifically limited, the functionality described in relation to a plurality of computing devices may be integrated into a single computing device, or the various functionalities described in relation to a single computing device may be distributed across several computing devices. Further, in relation to the computing systems described herein-such as the contact center system 200 of FIG. 2—the various servers and computing devices thereof may be located on local computing devices 100 (e.g., on-site at the same physical location as the agents of the contact center), remote computing devices 100 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

As shown in the illustrated example, the computing device 100 may include a central processing unit (CPU) or processor 105 and a main memory 110. The computing device 100 may also include a storage device 115, a removable media interface 120, a network interface 125, an input/output (I/O) controller 130, and one or more input/output (I/O) devices 135. For example, as depicted, the I/O devices 135 may include a display device 135A, a keyboard 135B, and/or a pointing device 135C. The computing device 100 may further include additional elements, such as a memory port 140, a bridge 145, one or more I/O ports, one or more additional input/output (I/O) devices 135D, 135E, 135F, and/or a cache memory 150 in communication with the processor 105.

The processor 105 may be any logic circuitry that responds to and processes instructions fetched from the main memory 110. For example, the processor 105 may be implemented by an integrated circuit (e.g., a microprocessor, microcontroller, or graphics processing unit), or in a field-programmable gate array (FPGA) or application-specific integrated circuit (ASIC). As depicted, the processor 105 may communicate directly with the cache memory 150 via a secondary bus or backside bus. It should be appreciated that the cache memory 150 typically has a faster response time than the main memory 110. The main memory 110 may be one or more memory chips capable of storing data and allowing stored data to be directly accessed by the processor 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via and/or controlled by the I/O controller 130. Input devices may include, for example, a keyboard 135B and a pointing device 135C (e.g., a mouse or optical pen). Output devices may include, for example, video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

The computing device 100 may be any workstation, desktop computer, laptop or notebook computer, server machine, virtualized machine, mobile or smart phone, portable telecommunication device, media playing device, gaming system, mobile computing device, or any other type of computing, telecommunications or media device, without limitation, capable of performing the operations and functionality described herein. Although described in the singular for clarity and brevity of the description, the computing device 100 may include a plurality of devices connected by a network or connected to other systems and resources via a network. As used herein, a network may be embodied as or include one or more computing devices, machines, clients, client nodes, client machines, client computers, client devices, endpoints, or endpoint nodes in communication with one or more other computing devices, machines, clients, client nodes, client machines, client computers, client devices, endpoints, or endpoint nodes. For example, the network may be embodied as or include a private or public switched telephone network (PSTN), wireless carrier network, local area network (LAN), private wide area network (WAN), public WAN such as the Internet, etc., with connections being established using appropriate communication protocols. More generally, it should be understood that, unless otherwise limited, the computing device 100 may communicate with other computing devices 100 via any type of network using any suitable communication protocol. Further, the network may be a virtual network environment where various network components are virtualized. For example, the various machines may be virtual machines implemented as a software-based computer running on a physical machine, or a “hypervisor” type of virtualization may be used where multiple virtual machines run on the same host physical machine. Other types of virtualization may be employed in other embodiments.

Referring now to FIG. 2, a simplified block diagram of at least one embodiment of a communications infrastructure and/or content center system, which may be used in conjunction with one or more of the embodiments described herein, is shown. The contact center system 200 may be embodied as any system capable of providing contact center services (e.g., call center services, chat center services, SMS center services, etc.) to an end user and otherwise performing the functions described herein. The illustrative contact center system 200 includes a customer device 205, a network 210, a switch/media gateway 212, a call controller 214, an interactive media response (IMR) server 216, a routing server 218, a storage device 220, a statistics server 226, agent devices 230A, 230B, 230C, a media server 234, a knowledge management server 236, a knowledge system 238, chat server 240, web servers 242, an interaction (iXn) server 244, a universal contact server 246, a reporting server 248, a media services server 249, and an analytics module 250. Although only one customer device 205, one network 210, one switch/media gateway 212, one call controller 214, one IM R server 216, one routing server 218, one storage device 220, one statistics server 226, one media server 234, one knowledge management server 236, one knowledge system 238, one chat server 240, one iXn server 244, one universal contact server 246, one reporting server 248, one media services server 249, and one analytics module 250 are shown in the illustrative embodiment of FIG. 2, the contact center system 200 may include multiple customer devices 205, networks 210, switch/media gateways 212, call controllers 214, IMR servers 216, routing servers 218, storage devices 220, statistics servers 226, media servers 234, knowledge management servers 236, knowledge systems 238, chat servers 240, iXn servers 244, universal contact servers 246, reporting servers 248, media services servers 249, and/or analytics modules 250 in other embodiments. Further, in some embodiments, one or more of the components described herein may be excluded from the system 200, one or more of the components described as being independent may form a portion of another component, and/or one or more of the components described as forming a portion of another component may be independent.

It should be understood that the term “contact center system” is used herein to refer to the system depicted in FIG. 2 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 200), the associated customer service provider (such as a particular customer service provider providing customer services through the contact center system 200), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 200 may be used by a customer service provider to provide various types of services to customers. For example, the contact center system 200 may be used to engage and manage interactions in which automated processes (or bots) or human agents communicate with customers. As should be understood, the contact center system 200 may be an in-house facility to a business or enterprise for performing the functions of sales and customer service relative to products and services available through the enterprise. In another embodiment, the contact center system 200 may be operated by a third-party service provider that contracts to provide services for another organization. Further, the contact center system 200 may be deployed on equipment dedicated to the enterprise or third-party service provider, and/or deployed in a remote computing environment such as, for example, a private or public cloud environment with infrastructure for supporting multiple contact centers for multiple enterprises. The contact center system 200 may include software applications or programs, which may be executed on premises or remotely or some combination thereof. It should further be appreciated that the various components of the contact center system 200 may be distributed across various geographic locations and not necessarily contained in a single location or computing environment.

It should further be understood that, unless otherwise specifically limited, any of the computing elements of the technologies described herein may be implemented in cloud-based or cloud computing environments. As used herein and further described below in reference to the computing device 400, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

It should be understood that any of the computer-implemented components, modules, or servers described in relation to FIG. 2 may be implemented via one or more types of computing devices, such as, for example, the computing device 100 of FIG. 1. As will be seen, the contact center system 200 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 200 may initiate inbound communications (e.g., telephone calls, emails, chats, etc.) to the contact center system 200 via a customer device 205. While FIG. 2 shows one such customer device—i.e., customer device 205—it should be understood that any number of customer devices 205 may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center system 200, such as telephone calls, emails, chats, text messages, web-browsing sessions, and other multi-media transactions.

Inbound and outbound communications from and to the customer devices 205 may traverse the network 210, with the nature of the network typically depending on the type of customer device being used and the form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 212 may be coupled to the network 210 for receiving and transmitting telephone calls between customers and the contact center system 200. The switch/media gateway 212 may include a telephone or communication switch configured to function as a central switch for agent level routing within the center. The switch may be a hardware switching system or implemented via software. For example, the switch 212 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. Thus, in general, the switch/media gateway 212 establishes a voice connection between the customer and the agent by establishing a connection between the customer device 205 and agent device 230.

As further shown, the switch/media gateway 212 may be coupled to the call controller 214 which, for example, serves as an adapter or interface between the switch and the other routing, monitoring, and communication-handling components of the contact center system 200. The call controller 214 may be configured to process PSTN calls, VoIP calls, and/or other types of calls. For example, the call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

The interactive media response (IMR) server 216 may be configured to enable self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may instruct customers via the IMR script to “press 1” if they wish to retrieve their account balance. Through continued interaction with the IMR server 216, customers may receive service without needing to speak with an agent. The IMR server 216 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment (e.g., Genesys® Designer).

The routing server 218 may function to route incoming interactions. For example, once it is determined that an inbound communication should be handled by a human agent, functionality within the routing server 218 may select the most appropriate agent and route the communication thereto. This agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described herein, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230. This information is intended to enhance the service the agent is able to provide to the customer.

It should be appreciated that the contact center system 200 may include one or more mass storage devices-represented generally by the storage device 220—for storing data in one or more databases relevant to the functioning of the contact center. For example, the storage device 220 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database. Agent data maintained by the contact center system 200 may include, for example, agent availability and agent profiles, schedules, skills, handle time, and/or other relevant data. As another example, the storage device 220 may store interaction data in an interaction database. Interaction data may include, for example, data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center system 200 in ways that facilitate the functionality described herein. For example, the servers or modules of the contact center system 200 may query such databases to retrieve data stored therein or transmit data thereto for storage. The storage device 220, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 226 may be configured to record and aggregate data relating to the performance and operational aspects of the contact center system 200. Such information may be compiled by the statistics server 226 and made available to other servers and modules, such as the reporting server 248, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center system 200 may be communication devices configured to interact with the various components and modules of the contact center system 200 in ways that facilitate functionality described herein. An agent device 230, for example, may include a telephone adapted for regular telephone calls or VoIP calls. An agent device 230 may further include a computing device configured to communicate with the servers of the contact center system 200, perform data processing associated with operations, and interface with customers via voice, chat, email, and other multimedia communication mechanisms according to functionality described herein. Although FIG. 2 shows three such agent devices 230—i.e., agent devices 230A, 230B and 230C—it should be understood that any number of agent devices 230 may be present in a particular embodiment.

The multimedia/social media server 234 may be configured to facilitate media interactions (other than voice) with the customer devices 205 and/or the servers 242. Such media interactions may be related, for example, to email, voice mail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management server 236 may be configured to facilitate interactions between customers and the knowledge system 238. In general, the knowledge system 238 may be a computer system capable of receiving questions or queries and providing answers in response. The knowledge system 238 may be included as part of the contact center system 200 or operated remotely by a third party. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials. As an example, the knowledge system 238 may be embodied as IBM Watson or a similar system.

The chat server 240, it may be configured to conduct, orchestrate, and manage electronic chat communications with customers. In general, the chat server 240 is configured to implement and maintain chat conversations and generate chat transcripts. Such chat communications may be conducted by the chat server 240 in such a way that a customer communicates with automated chatbots, human agents, or both. In exemplary embodiments, the chat server 240 may perform as a chat orchestration server that dispatches chat conversations among the chatbots and available human agents. In such cases, the processing logic of the chat server 240 may be rules driven so to leverage an intelligent workload distribution among available chat resources. The chat server 240 further may implement, manage, and facilitate user interfaces (UIs) associated with the chat feature, including those UIs generated at either the customer device 205 or the agent device 230. The chat server 240 may be configured to transfer chats within a single chat session with a particular customer between automated and human sources such that, for example, a chat session transfers from a chatbot to a human agent or from a human agent to a chatbot. The chat server 240 may also be coupled to the knowledge management server 236 and the knowledge systems 238 for receiving suggestions and answers to queries posed by customers during a chat so that, for example, links to relevant articles can be provided.

The web servers 242 may be included to provide site hosts for a variety of social interaction sites to which customers subscribe, such as Facebook, Twitter, Instagram, etc. Though depicted as part of the contact center system 200, it should be understood that the web servers 242 may be provided by third parties and/or maintained remotely. The web servers 242 may also provide webpages for the enterprise or organization being supported by the contact center system 200. For example, customers may browse the webpages and receive information about the products and services of a particular enterprise. Within such enterprise webpages, mechanisms may be provided for initiating an interaction with the contact center system 200, for example, via web chat, voice, or email. An example of such a mechanism is a widget, which can be deployed on the webpages or websites hosted on the web servers 242. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 244 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 244 may be configured to interact with the routing server 218 for selecting an appropriate agent to handle each of the deferrable activities. Once assigned to a particular agent, the deferrable activity is pushed to that agent so that it appears on the agent device 230 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 230 may include a workbin. As an example, a workbin may be maintained in the buffer memory of the corresponding agent device 230.

The universal contact server (UCS) 246 may be configured to retrieve information stored in the customer database and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 249 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 250 may be configured to provide systems and methods for performing analytics on data received from a plurality of different data sources as functionality described herein may require. In accordance with example embodiments, the analytics module 250 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the technologies described herein to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 250 may have access to the data stored in the storage device 220, including the customer database and agent database. The analytics module 250 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 250 may be configured to retrieve data stored within the storage device 220 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 250 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 250 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers in various embodiments. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment. It should be appreciated that each of the devices of the contact center system 200 may be embodied as, include, or form a portion of one or more computing devices similar to the computing device 100 described below in reference to FIG. 1.

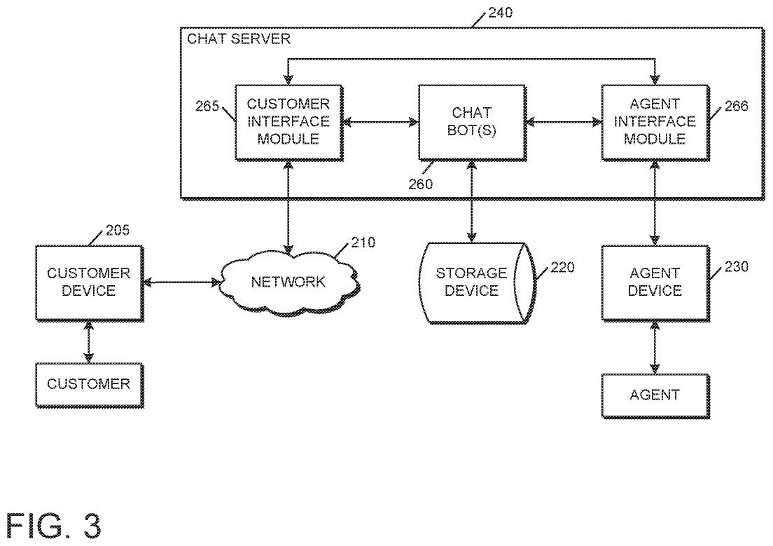

Referring now to FIGS. 3, 4 and 5, various aspects of chat systems and chatbots are shown. As will be seen, present embodiments may include or be enabled by such chat features, which, in general, enable the exchange of text messages between different parties. Those parties may include live persons, such as customers and agents, as well as automated processes, such as bots or chatbots.

It should be appreciated that a bot (also known as an “Internet bot”) is a software application that runs automated tasks or scripts over the Internet. In many circumstances, bots may perform tasks that are both simple and structurally repetitive at a much higher rate than would be possible for a person. A chatbot is a particular type of bot and, as used herein, is defined as a piece of software and/or hardware that conducts a conversation via auditory or textual methods. As will be appreciated, chatbots are often designed to convincingly simulate how a human would behave as a conversational partner. Chatbots are typically used in dialog systems for various practical purposes including customer service or information acquisition. Some chatbots use sophisticated natural language processing systems, while simpler ones scan for keywords within the input and then select a reply from a database based on matching keywords or wording pattern.

Whether or not the subsequent reference includes the corresponding numerical identifiers used in the figures previously described, it should be understood that the reference incorporates the example described in the previous figures and, unless otherwise specifically limited, may be implemented in accordance with either that examples or other technology capable of fulfilling the desired functionality, as would be understood by one of ordinary skill in the art. Thus, for example, subsequent mention of a “contact center system” should be understood as referring to the exemplary “contact center system 200” of FIG. 2 and/or other technologies for implementing a contact center system. As additional examples, a subsequent mention below to a “customer device”, “agent device”, “chat server”, or “computing device” should be understood as referring to the exemplary “customer device 205”, “agent device 230”, “chat server 240”, or “computing device 200”, respectively, of FIGS. 1-2, as well as technology for fulfilling the same functionality.

Chat features and chatbots will now be discussed in greater specificity with reference to the exemplary embodiments of a chat server, chatbot, and chat interface depicted, respectively, in FIGS. 3, 4, and 5. While these examples are provided with respect to chat systems implemented on the contact center-side, such chat systems may be used on the customer-side of an interaction. Thus, it should be understood that the exemplary chat systems of FIGS. 3, 4, and 5 may be modified for analogous customer-side implementation, including the use of customer-side chatbots configured to interact with agents and chatbots of contact centers on a customer's behalf. It should further be understood that chat features may be utilized by voice communications via converting text-to-speech and/or speech-to-text.

Referring specifically now to FIG. 3, a more detailed block diagram is provided of a chat server 240, which may be used to implement chat systems and features. The chat server 240 may be coupled to (i.e., in electronic communication with) a customer device 205 operated by the customer over a data communications network 210. The chat server 240, for example, may be operated by an enterprise as part of a contact center for implementing and orchestrating chat conversations with the customers, including both automated chats and chats with human agents. In regard to automated chats, the chat server 240 may host chat automation modules or chatbots 260A-260C (collectively referenced as 260), which are configured with computer program instructions for engaging in chat conversations. Thus, generally, the chat server 240 implements chat functionality, including the exchange of text-based or chat communications between a customer device 205 and an agent device 230 or a chatbot 260. As discussed more below, the chat server 240 may include a customer interface module 265 and agent interface module 266 for generating particular UIs at the customer device 205 and the agent device 230, respectively, that facilitate chat functionality.

In regard to the chatbots 260, each can operate as an executable program that is launched according to demand. For example, the chat server 240 may operate as an execution engine for the chatbots 260, analogous to loading VoiceXML files to a media server for interactive voice response (IVR) functionality. Loading and unloading may be controlled by the chat server 240, analogous to how a VoiceXML script may be controlled in the context of an interactive voice response. The chat server 240 may further provide a means for capturing and collecting customer data in a unified way, similar to customer data capturing in the context of IVR. Such data can be stored, shared, and utilized in a subsequent conversation, whether with the same chatbot, a different chatbot, an agent chat, or even a different media type. In example embodiments, the chat server 240 is configured to orchestrate the sharing of data among the various chatbots 260 as interactions are transferred or transitioned over from one chatbot to another or from one chatbot to a human agent. The data captured during interaction with a particular chatbot may be transferred along with a request to invoke a second chatbot or human agent.

In exemplary embodiments, the number of chatbots 260 may vary according to the design and function of the chat server 240. Further, different chatbots may be created to have different profiles, which can then be selected between to match the subject matter of a particular chat or a particular customer. For example, the profile of a particular chatbot may include expertise for helping a customer on a particular subject or communication style aimed at a certain customer preference. More specifically, one chatbot may be designed to engage in a first topic of communication (e.g., opening a new account with the business), while another chatbot may be designed to engage in a second topic of communication (e.g., technical support for a product or service provided by the business). Or, chatbots may be configured to utilize different dialects or slang or have different personality traits or characteristics. Engaging chatbots with profiles that are catered to specific types of customers may enable more effective communication and results. The chatbot profiles may be selected based on information known about the other party, such as demographic information, interaction history, or data available on social media. The chat server 240 may host a default chatbot that is invoked if there is insufficient information about the customer to invoke a more specialized chatbot. Optionally, the different chatbots may be customer selectable. In exemplary embodiments, profiles of chatbots 260 may be stored in a profile database hosted in the storage device 220. Such profiles may include the chatbot's personality, demographics, areas of expertise, and the like.

The customer interface module 265 and agent interface module 266 may be configured to generate user interfaces (UIs) for display on the customer device 205 that facilitate chat communications between the customer and a chatbot 260 or human agent. Likewise, an agent interface module 266 may generate particular UIs on the agent device 230 that facilitate chat communications between an agent operating an agent device 230 and the customer. The agent interface module 266 may also generate UIs on an agent device 230 that allow an agent to monitor aspects of an ongoing chat between a chatbot 260 and a customer. For example, the customer interface module 265 may transmit signals to the customer device 205 during a chat session that are configured to generated particular UIs on the customer device 205, which may include the display of the text messages being sent from the chatbot 260 or human agent as well as other non-text graphics that are intended to accompany the text messages, such as emoticons or animations. Similarly, the agent interface module 266 may transmit signals to the agent device 230 during a chat session that are configured to generated UIs on the agent device 230. Such UIs may include an interface that facilitates the agent selection of non-text graphics for accompanying outgoing text messages to customers.

In exemplary embodiments, the chat server 240 may be implemented in a layered architecture, with a media layer, a media control layer, and the chatbots executed by way of the IMR server 216 (similar to executing a VoiceXML on an IVR media server). As described above, the chat server 240 may be configured to interact with the knowledge management server 234 to query the server for knowledge information. The query, for example, may be based on a question received from the customer during a chat. Responses received from the knowledge management server 234 may then be provided to the customer as part of a chat response.

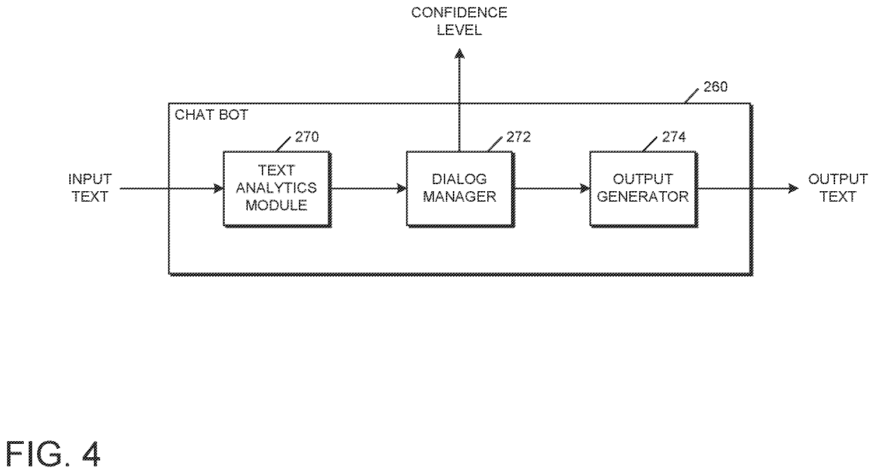

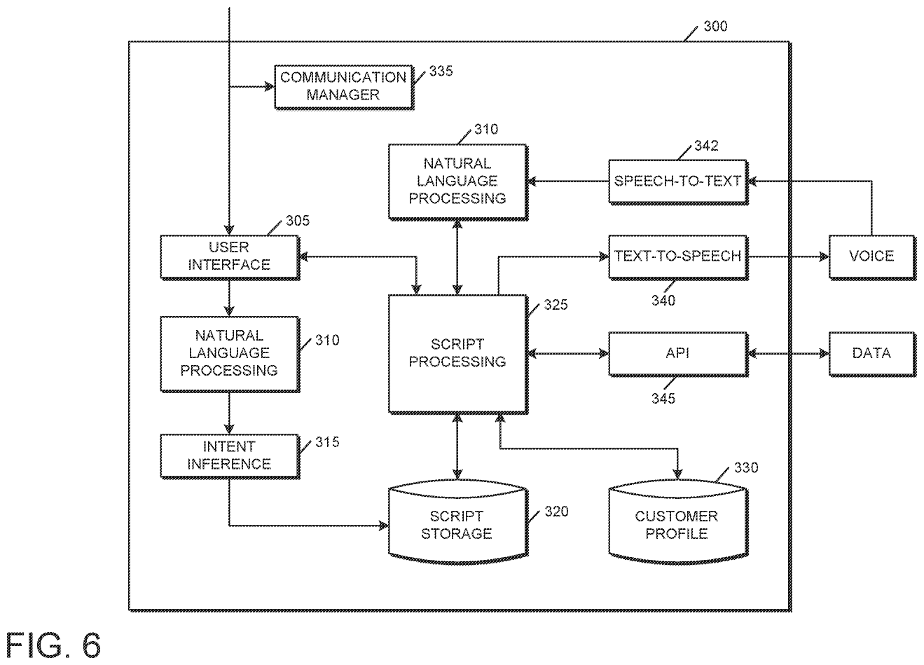

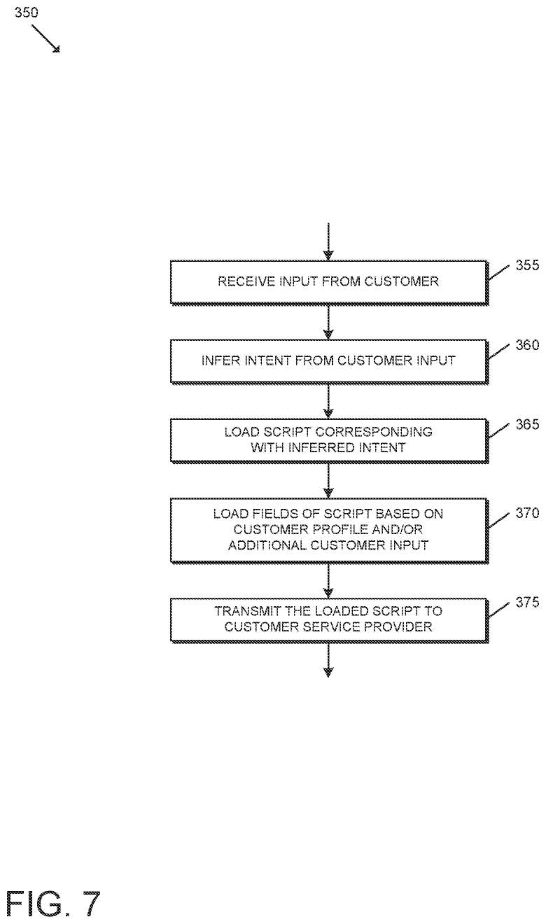

Referring specifically now to FIG. 4, a block diagram is provided of an exemplary chat automation module or chatbot 260. As illustrated, the chatbot 260 may include several modules, including a text analytics module 270, dialog manager 272, and output generator 274. It will be appreciated that, in a more detailed discussion of chatbot operability, other subsystems or modules may be described, including, for examples, modules related to intent recognition, text-to-speech or speech-to-text modules, as well as modules related to script storage, retrieval, and data field processing in accordance with information stored in agent or customer profiles. Such topics, however, are covered more completely in other areas of this disclosure—for example, in relation to FIGS. 6 and 7—and so will not be repeated here for brevity of the description. It should nevertheless be understood that the disclosures made in these areas may be used in analogous ways toward chatbot operability in accordance with functionality described herein.

The text analytics module 270 may be configured to analyze and understand natural language. In this regard, the text analytics module may be configured with a lexicon of the language, syntactic/semantic parser, and grammar rules for breaking a phrase provided by the customer device 205 into an internal syntactic and semantic representation. The configuration of the text analytics module depends on the particular profile associated with the chatbot. For example, certain words may be included in the lexicon for one chatbot but excluded that of another.

The dialog manager 272 receives the syntactic and semantic representation from the text analytics module 270 and manages the general flow of the conversation based on a set of decision rules. In this regard, the dialog manager 272 maintains a history and state of the conversation and, based on those, generates an outbound communication. The communication may follow the script of a particular conversation path selected by the dialog manager 272. As described in further detail below, the conversation path may be selected based on an understanding of a particular purpose or topic of the conversation. The script for the conversation path may be generated using any of various languages and frameworks conventional in the art, such as, for example, artificial intelligence markup language (AIML), SCXML, or the like.

During the chat conversation, the dialog manager 272 selects a response deemed to be appropriate at the particular point of the conversation flow/script and outputs the response to the output generator 274. In exemplary embodiments, the dialog manager 272 may also be configured to compute a confidence level for the selected response and provide the confidence level to the agent device 230. Every segment, step, or input in a chat communication may have a corresponding list of possible responses. Responses may be categorized based on topics (determined using a suitable text analytics and topic detection scheme) and suggested next actions are assigned. Actions may include, for example, responses with answers, additional questions, transfer to a human agent to assist, and the like. The confidence level may be utilized to assist the system with deciding whether the detection, analysis, and response to the customer input is appropriate or whether a human agent should be involved. For example, a threshold confidence level may be assigned to invoke human agent intervention based on one or more business rules. In exemplary embodiments, confidence level may be determined based on customer feedback. As described, the response selected by the dialog manager 272 may include information provided by the knowledge management server 234.

In exemplary embodiments, the output generator 274 takes the semantic representation of the response provided by the dialog manager 272, maps the response to a chatbot profile or personality (e.g., by adjusting the language of the response according to the dialect, vocabulary, or personality of the chatbot), and outputs an output text to be displayed at the customer device 205. The output text may be intentionally presented such that the customer interacting with a chatbot is unaware that it is interacting with an automated process as opposed to a human agent. As will be seen, in accordance with other embodiments, the output text may be linked with visual representations, such as emoticons or animations, integrated into the customer's user interface.

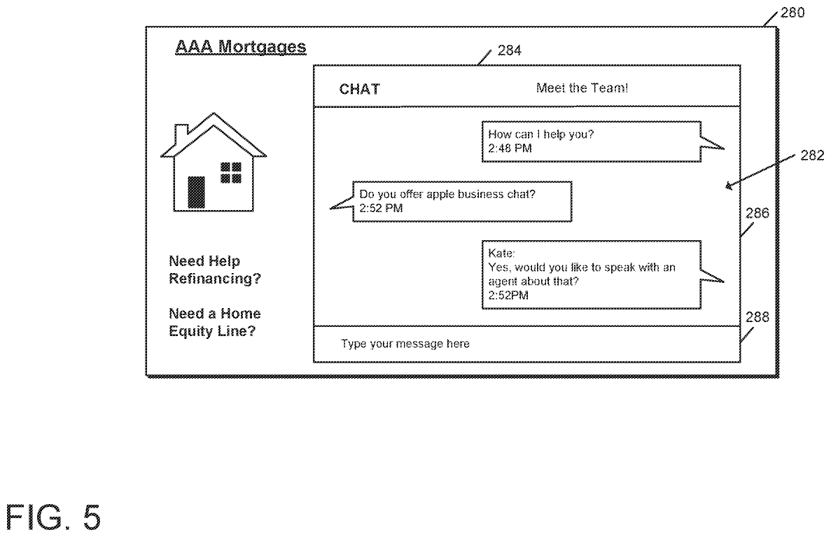

Referring now to FIG. 5, a webpage 280 having an exemplary implementation of a chat feature 282 is shown. The webpage 280, for example, may be associated with an enterprise website and intended to initiate interaction between prospective or current customers visiting the webpage and a contact center associated with the enterprise. As will be appreciated, the chat feature 282 may be generated on any type of customer device 205, including personal computing devices such as laptops, tablet devices, or smart phones. Further, the chat feature 282 may be generated as a window within a webpage or implemented as a full-screen interface. As in the example shown, the chat feature 282 may be contained within a defined portion of the webpage 280 and, for example, may be implemented as a widget via the systems and components described above and/or any other conventional means. In general, the chat feature 282 may include an exemplary way for customers to enter text messages for delivery to a contact center.

As an example, the webpage 280 may be accessed by a customer via a customer device, such as the customer device, which provides a communication channel for chatting with chatbots or live agents. In exemplary embodiments, as shown, the chat feature 282 includes generating a user interface, which is referred to herein as a customer chat interface 284, on a display of the customer device. The customer chat interface 284, for example, may be generated by the customer interface module of a chat server, such as the chat server, as already described. As described, the customer interface module 265 may send signals to the customer device 205 that are configured to generate the desired customer chat interface 284, for example, in accordance with the content of a chat message issued by a chat source, which, in the example, is a chatbot or agent named “Kate”. The customer chat interface 284 may be contained within a designated area or window, with that window covering a designated portion of the webpage 280. The customer chat interface 284 also may include a text display area 286, which is the area dedicated to the chronological display of received and sent text messages. The customer chat interface 284 further includes a text input area 288, which is the designated area in which the customer inputs the text of their next message. It should be appreciated that other configurations may be used in other embodiments.

It should be appreciated that various systems and methods may be used for automating and augmenting customer actions during various stages of interaction with a customer service provider or contact center. Those various stages of interaction may be classified as pre-contact, during-contact, and post-contact stages (or, respectively, pre-interaction, during-interaction, and post-interaction stages). With specific reference now to FIG. 6, an exemplary customer automation system 300 is shown that may be used in conjunction with the various technologies described herein. To better explain how the customer automation system 300 functions, reference will also be made to FIG. 7, which provides a flowchart 350 of an exemplary method for automating customer actions when, for example, the customer interacts with a contact center. Additional information related to customer automation are provided in U.S. patent application Ser. No. 16/151,362, filed on Oct. 4, 2018, entitled “System and Method for Customer Experience Automation,” the contents of which are incorporated herein by reference.

The customer automation system 300 of FIG. 6 represents a system that may be used for customer-side automations, which, as used herein, refers to the automation of actions taken on behalf of a customer in interactions with customer service providers or contact centers. Such interactions may also be referred to as “customer-contact center interactions” or simply “customer interactions”. Further, in discussing such customer-contact center interactions, it should be appreciated that reference to a “contact center” or “customer service provider” is intended to generally refer to any customer service department or other service provider associated with an organization or enterprise (such as, for example, a business, governmental agency, non-profit, school, etc.) with which a user or customer has business, transactions, affairs or other interests.

In exemplary embodiments, the customer automation system 300 may be implemented as a software program or application running on a mobile device or other computing device, cloud computing devices (e.g., computer servers connected to the customer device 205 over a network), or combinations thereof (e.g., some modules of the system are implemented in the local application while other modules are implemented in the cloud. For the sake of convenience, embodiments are primarily described in the context of implementation via an application running on the customer device 205. However, it should be understood that present embodiments are not limited thereto.

The customer automation system 300 may include several components or modules. In the illustrated example of FIG. 6, the customer automation system 300 includes a user interface 305, natural language processing (NLP) module 310, intent inference module 315, script storage module 320, script processing module 325, customer profile database or module (or simply “customer profile”) 330, communication manager module 335, text-to-speech module 340, speech-to-text module 342, and application programming interface (API) 345, each of which will be described with more particularity with reference also to flowchart 350 of FIG. 7. It will be appreciated that some of the components of and functionalities associated with the customer automations system 300 may overlap with the chatbot systems described above in relation to FIGS. 3, 4, and 5. In cases where the customer automation system 300 and such chatbot systems are employed together as part of a customer-side implementation, such overlap may include the sharing of resources between the two systems.

In an example of operation, with specific reference now to the flowchart 350 of FIG. 7, the customer automation system 300 may receive input at an initial step or operation 355. Such input may come from several sources. For example, a primary source of input may be the customer, where such input is received via the customer device. The input also may include data received from other parties, particularly parties interacting with the customer through the customer device. For example, information or communications sent to the customer from the contact center may provide aspects of the input. In either case, the input may be provided in the form of free speech or text (e.g., unstructured, natural language input). Input also may include other forms of data received or stored on the customer device.

Continuing with the flowchart 350, at an operation 360, the customer automation system 300 parses the natural language of the input using the NLP module 310 and, therefrom, infers an intent using the intent inference module 315. For example, where the input is provided as speech from the customer, the speech may be transcribed into text by a speech-to-text system (such as a large vocabulary continuous speech recognition or LVCSR system) as part of the parsing by the NLP module 310. The transcription may be performed locally on the customer device 205 or the speech may be transmitted over a network for conversion to text by a cloud-based server. In certain embodiments, for example, the intent inference module 315 may automatically infer the customer's intent from the text of the provided input using artificial intelligence or machine learning techniques. Such artificial intelligence techniques may include, for example, identifying one or more keywords from the customer input and searching a database of potential intents corresponding to the given keywords. The database of potential intents and the keywords corresponding to the intents may be automatically mined from a collection of historical interaction recordings. In cases where the customer automation system 300 fails to understand the intent from the input, a selection of several intents may be provided to the customer in the user interface 305. The customer may then clarify their intent by selecting one of the alternatives or may request that other alternatives be provided.

After the customer's intent is determined, the flowchart 350 proceeds to an operation 365 where the customer automation system 300 loads a script associated with the given intent. Such scripts, for example, may be stored and retrieved from the script storage module 320. Such scripts may include a set of commands or operations, pre-written speech or text, and/or fields of parameters or data (also “data fields”), which represent data that is required to automate an action for the customer. For example, the script may include commands, text, and data fields that will be needed in order to resolve the issue specified by the customer's intent. Scripts may be specific to a particular contact center and tailored to resolve particular issues. Scripts may be organized in a number of ways, for example, in a hierarchical fashion, such as where all scripts pertaining to a particular organization are derived from a common “parent” script that defines common features. The scripts may be produced via mining data, actions, and dialogue from previous customer interactions. Specifically, the sequences of statements made during a request for resolution of a particular issue may be automatically mined from a collection of historical interactions between customers and customer service providers. Systems and methods may be employed for automatically mining effective sequences of statements and comments, as described from the contact center agent side, are described in U.S. patent application Ser. No. 14/153,049, filed on Jan. 12, 2014, entitled “Computing Suggested Actions in Caller Agent Phone Calls By Using Real-Time Speech Analytics and Real-Time Desktop Analytics,” the contents of which are incorporated by reference herein.

With the script retrieved, the flowchart 350 proceeds to an operation 370 where the customer automation system 300 processes or “loads” the script. This action may be performed by the script processing module 325, which performs it by filling in the data fields of the script with appropriate data pertaining to the customer. More specifically, the script processing module 325 may extract customer data that is relevant to the anticipated interaction, with that relevance being predetermined by the script selected as corresponding to the customer's intent. The data for many of the data fields within the script may be automatically loaded with data retrieved from data stored within the customer profile 330. As will be appreciated, the customer profile 330 may store particular data related to the customer, for example, the customer's name, birth date, address, account numbers, authentication information, and other types of information relevant to customer service interactions. The data selected for storage within the customer profile 330 may be based on data the customer has used in previous interactions and/or include data values obtained directly by the customer. In case of any ambiguity regarding the data fields or missing information within a script, the script processing module 325 may include functionality that prompts and allows the customer to manually input the needed information.

Referring again to the flowchart 350, at an operation 375, the loaded script may be transmitted to the customer service provider or contact center. As discussed more below, the loaded script may include commands and customer data necessary to automate at least a part of an interaction with the contact center on the customer's behalf. In exemplary embodiments, an API 345 is used so to interact with the contact center directly. Contact centers may define a protocol for making commonplace requests to their systems, which the API 345 is configured to do. Such APIs may be implemented over a variety of standard protocols such as Simple Object Access Protocol (SOAP) using Extensible Markup Language (XML), a Representational State Transfer (REST) API with messages formatted using XML or JavaScript Object Notation (JSON), and the like. Accordingly, the customer automation system 300 may automatically generate a formatted message in accordance with a defined protocol for communication with a contact center, where the message contains the information specified by the script in appropriate portions of the formatted message

The technologies described herein involve various systems and methods for training an artificial intelligence system to handle long-tail interactions. It should be appreciated that a long-tail bot may have the ability to answer more unique questions with the use of artificial intelligence, while a short-tail bot generally handles simple question that are common (e.g., frequently asked questions). Some solutions may use a combination of a long-tail and a short-tail bot. A long-tail bot requires training in the domain of use by subject-matter experts. Accordingly, a machine learning model is necessary for the bot to fully grasp the domain and be able to understand, learn, and reason. The machine learning model is further required for understanding of the meaning and intention of the user's input, and is more niched and detailed than would be for a short-tail bot. Long-tail bots are usually applied in a narrow field and consequently only have depth in that narrow field. However, bots generally lack the ability to efficiently adapt for long-tail questions and answers, which are beyond the typical frequently asked questions (FAQ). For example, questions may require empathy or experience with the product or solution that the user is referring to in their query for an effective reply.

Currently, a bot trains/adapts when an artificial intelligence developer takes the time to tag, manage, curate, and prepare questions and answer for any given topic (e.g., the domain of use). This is effective where the question frequency is high. However, when the long-tail questions/answers are lower in volume and higher in complexity, there is not an efficient way to deliver high quality training material to the bot. Thus, the addition of the long-tail questions/answers is generally ad hoc, manual, and expensive.

Solutions to addressing the long-tail questions/answers may include the use of contact center agents, outsourced resources, and/or gig economy experts. More specifically, in a contact center setting, agents may be used to bridge the knowledge gap of the bot. However, many of those agents do not even own the products that are relevant to the queries from the users/customers. The agents themselves are often also not situated like their prospects and customers and, therefore, cannot speak with empathy to the interaction. Additionally, outsourced resources typically have little knowledge of the relevant products and, therefore, it is coincidental if they are situated like the prospects and customers. The customer experience may suffer as a result. In yet another example, experts may be introduced in the contact center environment to explicitly address long-tail experience/empathy questions, but this solution can become repetitive if the experts are answering the same questions more than once.

It should be appreciated that a gig economy comprises a labor market characterized by the prevalence of short-term contracts or freelance work as opposed to permanent jobs. In the application of a gig economy to a contact center environment, an enterprise is able to pay existing customers to respond to questions from new customers or prospects. The approach described herein to knowledge delivery to new customers and prospects creates a base of knowledge for long-tail questions/answers. The new knowledge base may then be used as a source of training for the bot for long-tail questions/answers as further described in embodiments herein. Artificial intelligence automation may be applied to questions previously too complex or unique for traditional contact center resources to address. Thus, a foundation of gig experts and existing customers may be built on to deliver the best answer in order to be rated most highly for their particular skill in answering a question.

In some embodiments, an Expert Answered Questions (EAQ) bot is trained on questions that have been answered by experts. Answers may be vetted in many ways. By way of example, an answer may come from a well-rated expert, the answer may be favorably reviewed by at least one other expert, the customer may have rated the answer as matching the question at above a threshold level (e.g., 75%), and/or the customer may have rated the quality of the answer at above a threshold level (e.g., 75%). In such embodiments, it should be appreciated that the various thresholds may be predefined and/or modifiable by the system.

It should be appreciated that questions (e.g., particularly long-tail questions) may require experience or empathy to answer. The relevant experience may be with a particular product, solution, issue, or topic associated with the contact center and the interaction which a customer is engaged in with the representative of the contact center (e.g., agent or bot). Empathy may be relevant in the expert's ability to understand and share the feelings of another, thus, providing the customer with a satisfactory customer experience in which, for example, they feel connected or understood. It should be appreciated that the EAQ bot may be similar to an FAQ (Frequently Asked Questions) bot in provided automated answers. However, in some embodiments, the EAQ bot may have highly specialized question/answer sets used for its training. In some embodiments, the FAQ bot may be provided with the first opportunity to answer queries from customers, and if the confidence recognition match on the question is low, the EAQ bot may be given the chance to answer the question. In other embodiments, however, it should be appreciated that a single bot may be used (e.g., addressing potential FAQ solutions before addressing potential EAQ solutions).

In an embodiment, suppose the EAQ bot's confidence recognition match on the question match is also low. In such circumstances, the question may then be directed to an expert (e.g., for real-time resolution). But, if the EAQ bot's confidence recognition match on the question is high, then the EAQ bot may simply respond with the answer previously given by the expert (e.g., stored in an expert answer knowledgebase). In some embodiments, the expert answer may be provided along with details about the expert to sufficiently convey the customer that the answer was provided by an expert. For example, an answer might read “Bob S., who also owns a vehicle similar to yours, says that wind noise is negligible at highway speeds.”

As described herein, a particular answer may have been added to the EAQ bot (or relevant knowledgebase) because the answer was provided to a customer and vetted in various ways. Thus, when a trusted expert answers a question, and that answer is rated satisfactory by another expert and/or a customer, then the question and answer may automatically be added to the EAQ bot training. The EAQ training may performed through one or more suitable natural language understanding (NLU) training methods on bots. Conversely, some answers may not pass one or more thresholds of acceptability (e.g., customer and/or secondary expert ratings, etc.), in which case those answers are not added to the EAQ bot or knowledgebase.

It should be appreciated that such features have several benefits such as enabling responses from gig economy experts to train the enterprise bot without requiring an artificial intelligence developer. Another benefit is that “bad answers” may be avoided in the EAQ training set. Additionally, in some embodiments, use ratings from prospects and new customers may be used to dictate which expert response should be used in training the bot. It should be further appreciated that the technologies described herein allow for the EAQ knowledge to be built incrementally from the approved answers given by experts, eliminating the typical steps of having an artificial intelligence expert perform the manual review of the question and the answer. In the gig economy model, enterprises rely and invest much more heavily on their best customers to provide credible answers to prospects and new customers. By capturing the responses, comparing the customer ratings, and incorporating suitable answers into the bot programmatically, enterprises can automatically improve their bots to provide a much more robust solution.

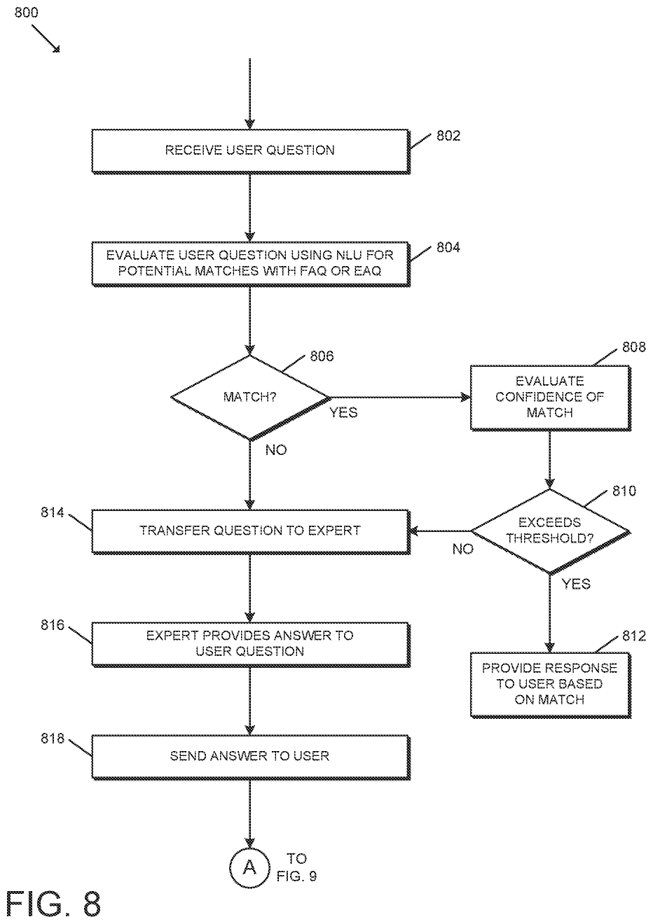

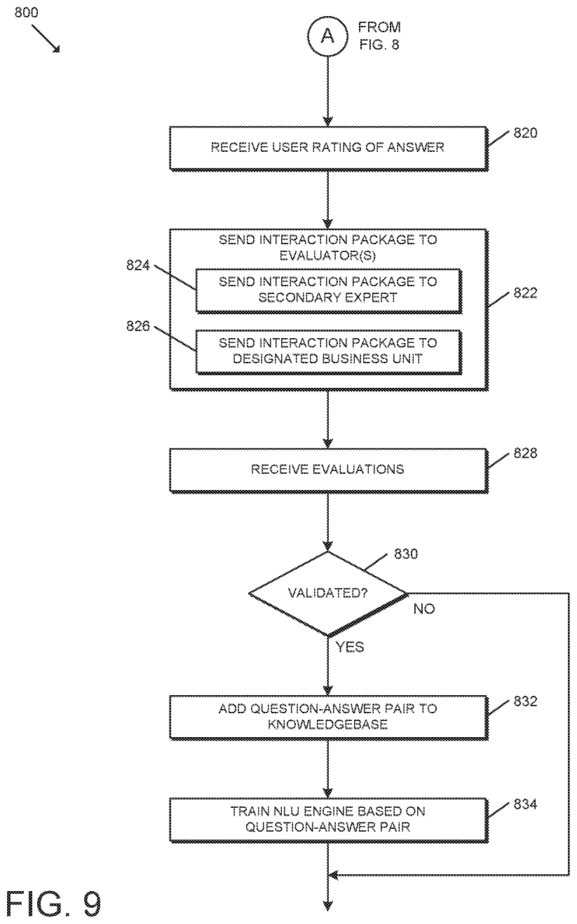

Referring now to FIGS. 8-9, in use, a computing system (e.g., the computing device 100, the contact center system 200, and/or other computing devices described herein) may execute a method 800 for training an artificial intelligence system to handle long-tail interactions. It should be appreciated that the particular blocks of the method 800 are illustrated by way of example, and such blocks may be combined or divided, added or removed, and/or reordered in whole or in part depending on the particular embodiment, unless stated to the contrary.

The illustrative method 800 begins with block 802 in which the system receives a user question from an interaction between a user and a chatbot. Although the interaction is described herein as being in the form of a chat-based conversation between the user and a chatbot of the system, it should be appreciated that the interaction may be between the user and other components of the system and/or via different communication channels in other embodiments (e.g., message board, email, SMS, etc.).

In block 804, the system analyzes the user question with a natural language understanding engine to determine an intent of the user question, and to determine whether the intent of the user question matches an answer in an answer knowledgebase of the system. For example, in some embodiments, the answer knowledgebase may include frequently asked questions (FAQs) and/or expert answered questions (EAQs). Further, it should be appreciated that the answer knowledgebase may include multiple knowledgebases, which may be stored together or separate depending on the particular embodiment. For example, in some embodiments, the answer knowledgebase may include an FAQ database/knowledgebase and an EAQ database/knowledgebase.

If the system determines, in block 806, that there is a potential match (e.g., full or partial), the method 800 advances to block 808 in which the system evaluates the confidence of the match. In some embodiments, the natural language understanding engine of the system may provide a confidence value that indicates how relevant a particular answer is to a question or, more specifically, a user intent inferred from the question. The system may have a predefined confidence threshold, above which a candidate answer is deemed to be a confident or likely match to the analyzed question. In some embodiments, it should be appreciated that portions of blocks 804-808 may be performed in conjunction with one another as part of the same function(s) and/or in parallel.

If, in block 810, the system determines that the confidence in the match exceeds the predefined threshold, the method 800 advances to block 812 in which the system provides a response including the matching answer to the user question to the user via the chatbot. However, if the system determines in block 806 that the user question does not match any of the answers in the answer knowledgebase or in block 810 that the confidence in a matching answer (or, more specifically, candidate answer) is insufficient, then the method 800 advances to block 814 in which the system transfers the user question to an expert. It should be appreciated that the user question may be transferred to the expert using any suitable technique depending on the particular embodiment. For example, in some embodiments, the interaction between the user and the chatbot is transferred to the expert such that the user can take over control of a real-time conversation with the user. In other embodiments, the system may simply transmit the user question to the expert for resolution. In block 816, the expert provides an answer to the user question, and in block 818, the system transmits a response including the expert answer to the user. It should be appreciated that the answer may be provided via a suitable communication channel depending on the manner in which the interaction (or user question) was transferred to the expert. Although the expert answer is essentially described as being transmitted to the user in real time prior to further vetting, it should be appreciated that the expert answer may be vetted by one or more evaluators as described herein prior to be transmitted to the user in other embodiments.

In block 820, the system receives one or more user ratings of the expert answer from the user. For example, in some embodiments, the user may rate the extent to which the answer matches the question that was posed by the user, the quality of the answer, and/or other characteristics associated with the answer. It should be appreciated that the rating scale may vary depending on the particular embodiment. For example, in some embodiments, the answer may be rated out of five stars, whereas in other embodiments, the answer may be rated based on a percentile scale.

In block 822, the system sends/transfers an interaction package to one or more evaluators for validation of the primary expert's answer to the user-posed question. More specifically, in block 824, the system may send the interaction package to a secondary expert for evaluation. Additionally, in block 826, the system may send the interaction package to one or more designated business units for evaluation. In the illustrative embodiment, the interaction package includes at least the user question and the corresponding expert answer. However, in other embodiments, the interaction package may include additional information that may provide addition context and/or information associated with the primary expert's answer. For example, in some embodiments, the interaction package may include the entire interaction/exchange between the user, chatbot, and primary expert. It should be appreciated that the secondary expert may serve to validate that the primary expert's answer to the user question was accurate. Further, in some embodiments, other characteristics of the expert answer may be evaluated such as succinctness, clarity, context, and/or other characteristics.

Further, it should be appreciated that various other business units may evaluate the answer depending on the particular client. For example, in some embodiments, a legal analyst may review the expert answer in order to ensure that the answer complies with legal policies. In another embodiment, an ethics analyst may review the expert answer in order to ensure that the expert answer is “on brand” from an ethical perspective. In other embodiments, various other business units/analysts may be designated to ensure that such sectors of the business have a stake in user-facing answers that will be used to further train an artificial intelligence model of the natural language understanding engine of the system.

In block 828, the system receives the evaluations of the one or more evaluators depending on the particular implementation. Like the user rating, it should be appreciated that the evaluator rating/evaluation may be provided based on any rating/evaluation scale suitable for performing the functions described herein. For example, in some embodiments, the evaluation may simply be a binary decision (e.g., satisfactory/unsatisfactory or approved/disapproved), whereas in other embodiments, the evaluation may provide a percentile or other indication of level of approval/satisfaction with the expert answer.

If the system, in block 830, confirms from the evaluations that the expert answer has been validated (e.g., approved by the secondary expert and/or other evaluators), the method 800 advances to block 832 in which the system adds a question-answer pair to the answer knowledgebase of the system corresponding with the user question and expert answer. In block 834, the system may automatically train the natural language understanding engine based on the user question and the expert answer. For example, the system may update an artificial intelligence model based on the new data (e.g., the question-answer pair). In some embodiments, it should be appreciated that successful validation of the expert answer may be further dependent on a positive customer rating.

As described above, in some embodiments, the secondary expert may evaluate the expert answer provided by the primary expert in real time prior to sending the answer to the user (e.g., even halting the communication if the answer is inaccurate or otherwise unacceptable), whereas in other embodiments, the system may trust the primary expert sufficiently to provide the expert answer to the user but then subsequently analyze the expert answer before using the answer for training the natural language understanding engine. It should be appreciated that the particular approach taken may be dictated by the various interests of the enterprise.

Although the blocks 802-834 are described in a relatively serial manner, it should be appreciated that various blocks of the method 800 may be performed in parallel in some embodiments.

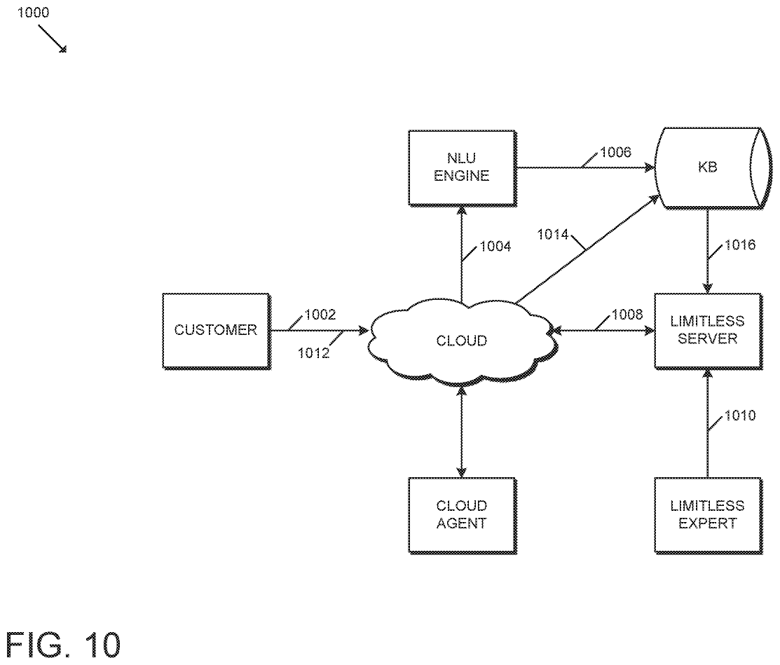

Referring now to FIG. 10, a simplified diagram of at least one embodiment of a system 1000 for leveraging gig customer service is shown. In the illustrative embodiment, in flow 1002, a customer asks a question of the enterprise (e.g., through SMS, chat, and/or another suitable communication channel) to a cloud system (e.g., a SaaS contact center platform).

In flow 1004, the cloud system sends the question to a natural language understanding (NLU) engine to determine if the question matches any known FAQs or long-tail EAQs stored in one or more knowledgebases of the system. In some embodiments, the NLU engine may be embodied as or include the Google Dialogflow platform and/or another suitable NLU platform for designing and integrating conversational user interfaces into a variety of apps, devices, IVR systems, and bots

In flow 1006, the natural language understanding engine checks for confidence in a match to the question against both the FAQ set and the EAQ set. A high confidence may result in an immediate return of the answer to the customer. A low (or no) confidence may result in sending the question to an expert. In the illustrative embodiment, the confidence is threshold based and customizable based on the needs or desires of the contact center/enterprise.

In flow 1008, the cloud system (e.g., of the contact center solution) sends the question to an expert for resolution. In flow 1010, the expert answers the question. Further, as described herein, it should be appreciated that the answer may also be reviewed by another expert for approval of the expert answer.

In flow 1012, the second expert evaluates the question-answer pair and, if the second expert approves the answer to the question, then the answer may be sent back through the cloud system (e.g., the contact center solution) to the customer. In flow 1014, the customer rates the expert answer and, in flow 1016, if the rating is high enough (e.g., exceeding a predetermined threshold value), the cloud system (e.g., the contact center solution) may submit the question-answer pair to the EAQ database/knowledgebase to be added, and the system may automatically retrain the natural language understanding engine based on the new question-answer pair.

What is claimed is:

1. A system for training an artificial intelligence system to handle long-tail interactions, the system comprising:
at least one processor; and
at least one memory comprising a plurality of instructions stored therein that, in response to execution by the at least one processor, causes the system to:
receive a user question from an interaction between a user and a chatbot;
analyze the user question with a natural language understanding engine to determine whether an intent of the user question matches an answer in an answer knowledgebase of the system;
transfer at least the user question of the interaction to a primary subject matter expert in response to a determination that the intent of the user question does not match an answer in the answer knowledgebase of the system;
receive an expert answer to the user question from the primary subject matter expert;
transfer an interaction package to at least one evaluator for validation, wherein the interaction package comprises the user question and the expert answer to the user question; and
automatically train the natural language understanding engine based on the user question and the expert answer in response to successful validation of the expert answer by the at least one evaluator.

2. The system of claim 1, wherein the at least one evaluator comprises a secondary subject matter expert.

3. The system of claim 1, wherein the plurality of instructions further causes the system to transmit a response to the user question to the user via the chatbot, wherein the response includes the expert answer.

4. The system of claim 3, wherein the plurality of instructions further causes the system to receive a user rating of a quality of the expert answer from the user.

5. The system of claim 4, wherein to automatically train the natural language understanding engine comprises to automatically train the natural language understanding engine in response to successful validation by the at least one evaluator and receipt of a favorable user rating of the quality of the expert answer from the user.

6. The system of claim 1, wherein the plurality of instructions further causes the system to transmit a matching answer to the user question via the chatbot in response to a determination that the intent of the user question matches an answer in the answer knowledgebase of the system.

7. The system of claim 1, wherein the plurality of instructions further causes the system to add a question-answer pair to the answer knowledgebase of the system in response to successful validation of the expert answer by the at least one evaluator.

8. The system of claim 1, wherein to train the natural language understanding engine comprises to update an artificial intelligence model.

9. The system of claim 1, wherein the answer knowledgebase comprises expert answered questions.

10. The system of claim 1, wherein the answer knowledgebase comprises frequently asked questions.

11. A method of training an artificial intelligence system to handle long-tail interactions, the method comprising:
receiving a user question from an interaction between a user and a chatbot;
analyzing the user question with a natural language understanding engine to determine whether an intent of the user question matches an answer in an answer knowledgebase of the system;
transferring at least the user question of the interaction to a primary subject matter expert in response to determining that the intent of the user question does not match an answer in the answer knowledgebase of the system;
receiving an expert answer to the user question from the primary subject matter expert;
transferring an interaction package to at least one evaluator for validation, wherein the interaction package comprises the user question and the expert answer to the user question; and
automatically training the natural language understanding engine based on the user question and the expert answer in response to successful validation of the expert answer by the at least one evaluator.

12. The method of claim 11, wherein the at least one evaluator comprises a secondary subject matter expert.

13. The method of claim 11, further comprising transmitting a response to the user question to the user via the chatbot that includes the expert answer.

14. The method of claim 13, further comprising receiving a user rating of a quality of the expert answer from the user.

15. The method of claim 14, wherein automatically training the natural language understanding engine comprises automatically training the natural language understanding engine in response to successful validation by the at least one evaluator and receipt of a favorable user rating of the quality of the expert answer from the user.

16. The method of claim 11, further comprising transmitting a matching answer to the user question via the chatbot in response to determining that the intent of the user question matches an answer in the answer knowledgebase of the system.

17. The method of claim 11, further comprising adding a question-answer pair to the answer knowledgebase of the system in response to successful validation of the expert answer by the at least one evaluator.

18. The method of claim 11, wherein training the natural language understanding engine comprises updating an artificial intelligence model.

19. The method of claim 11, wherein the answer knowledgebase comprises expert answered questions.

20. The method of claim 11, wherein the answer knowledgebase comprises frequently asked questions.
